(19) United States
(12) Patent Application Publication
(10) Pub. No.: US 2022/0360031 A1
(43) Pub. Date: Nov. 10, 2022

(54) Multifunctional Smart Socket

(71) Applicant: WENZHOU HUAYA ELECTRIC CO.,LTD, Leqing (CN)

(72) Inventor: Yunhua Lin, Leqing (CN)

(73) Assignee: WENZHOU HUAYA ELECTRIC CO.,LTD, Leqing (CN)

(21) Appl. No.: 17/826,165

(22) Filed: May 27, 2022

(30) Foreign Application Priority Data
Dec. 17, 2021 (CN) 202123184199.2

(51) Int. Cl. H01R 27/02; H01R 13/66

(52) U.S. Cl. CPC H01R 27/02; H01R 13/6683

(57) ABSTRACT

The present disclosure relates to a multifunctional smart socket. The multifunctional smart socket includes a housing, where a chip is arranged in the housing, a universal serial bus (USB) interface and a TYPE-C interface are provided on a panel of the housing; a multi-protocol quick charge module is arranged on the chip, and the USB interface and the TYPE-C interface are electrically connected to the multi-protocol quick charge module; and a main control module is further arranged on the chip, a first monitoring module and a second monitoring module are connected to the main control module, the first monitoring module is electrically connected to the USB interface, the second monitoring module is electrically connected to the TYPE-C interface, and the main control module controls the multi-protocol quick charge module to charge according to a signal of the first monitoring module or the second monitoring module.

### TECHNICAL FIELD

The present disclosure relates to the technical field of sockets, and in particular to a multifunctional smart socket.

### BACKGROUND

With the improvement of the scientific and technical level, electronic products such as mobile phones, digital cameras, mobile pentium 4 (MP4), recording pens and tablet personal computers play an increasingly important role in the life. However, these electronic products need to be charged frequently.

Most of existing sockets can only be used for performing common charge on devices and cannot achieve the function of quick charge.

### SUMMARY

The objective of the present disclosure is to provide a multifunctional smart socket, which may achieve quick charge and may automatically match a quick charge mode or a common charge mode according to an access device.

In order to achieve the above objective, the present disclosure provides the following technical solution:

a multifunctional smart socket includes a housing, where a chip is arranged in the housing, a universal serial bus (USB) interface and a TYPE-C interface are provided on a panel of the housing, a multi-protocol quick charge module is arranged on the chip, the USB interface and the TYPE-C interface are electrically connected to the multi-protocol quick charge module, a main control module is further arranged on the chip, a first monitoring module and a second monitoring module are connected to the main control module, the first monitoring module is electrically connected to the USB interface, the second monitoring module is electrically connected to the TYPE-C interface, and the main control module controls the multi-protocol quick charge module to charge according to a signal of the first monitoring module or the second monitoring module.

Further, the main control module is further connected to a rectifying and filtering module and a voltage transformation module, the rectifying and filtering module is connected to the voltage transformation module, and the voltage transformation module is connected to the multi-protocol quick charge module.

Further, the multi-protocol quick charge module supports a USB TypeC power delivery 2.0 (PD2.0)/power delivery 3.0 (PD3.0)/pulse per second dynamic feedback protocol (PPS DFP), quick charge 3.0 (QC3.0)/quick charge 2.0 (QC2.0), a fast charge protocol (FCP), a super charge protocol (SCP), adaptive fast charge (AFC), mediatek pump express plus 2.0/1.1 (MTK PE+2.0/1.1), Samsung 2.0A and a battery charging 1.2 (BC1.2) protocol.

The present disclosure has the beneficial effects: the present disclosure detects an access device by means of the first monitoring module and the second monitoring module, for example, when the first monitoring module detects that a charge device exists in the USB interface and the second monitoring module detects that no charge device exists in the TYPE-C interface, the first monitoring module sends the signal of the first monitoring module to the main control module, and the main control module controls the multi-protocol quick charge module to quickly charge the charge device in the USB interface; otherwise, if the second monitoring module detects that the charge device exists in the TYPE-C interface and the first monitoring module detects that no charge device exists in the USB interface, the second monitoring module sends the signal to the main control module, and the main control module controls the multi-protocol quick charge module to quickly charge the charge device in the TYPE-C interface; and when the signals are detected in the first monitoring module and the second monitoring module at the same time, the main control module controls the multi-protocol quick charge module to carry out common charge, where output voltage of quick charge and common charge ranges from 3 V to 20 V, where the output voltage of quick charge is preferably 20 V, and the output voltage of common charge is preferably 5 V, and charge power of quick charge and common charge is 65 W.

### BRIEF DESCRIPTION OF DRAWINGS

The drawings described herein serve to provide a further understanding of the present application and form a part hereof, and the illustrative embodiments of the present application and the description of the illustrative embodiments serve to explain the present application and are not to be construed as unduly limiting the present application. In the drawings:

FIG. 1 is a structural schematic diagram of an embodiment of the present disclosure.

FIG. 2 is a cutaway view of an embodiment of the present disclosure.

FIG. 3 is a functional block diagram of an embodiment of the present disclosure.

Reference numerals: 10, housing; 20, chip; 30, universal serial bus (USB) interface; 40, TYPE-C interface; 50, main control module; 60, first monitoring module; 70, second monitoring module; 80, rectifying and filtering module; 90, voltage transformation module; 100, panel; and 110, multi-protocol quick charge module.

### DETAILED DESCRIPTION OF THE EMBODIMENTS

The implementation of the present application will be described in detail below with reference to the accompanying drawings and embodiments, such that an implementation process of how the present application applies technical means to solve the technical problem and achieve technical effects may be fully understood and implemented.

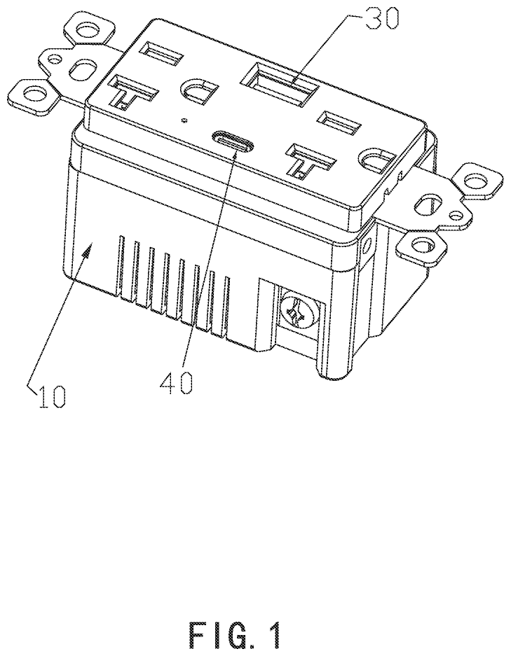

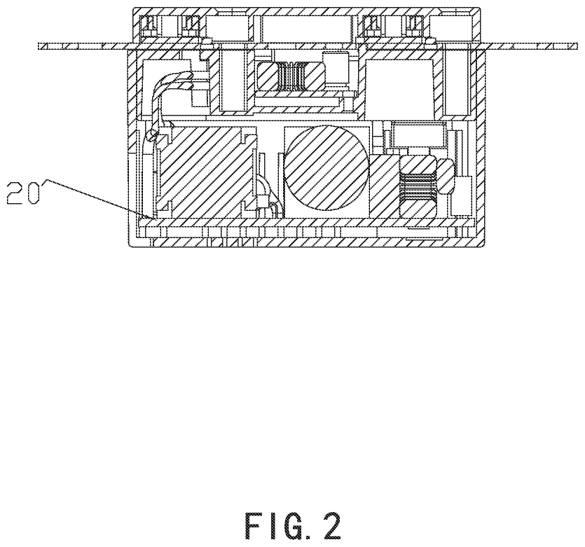

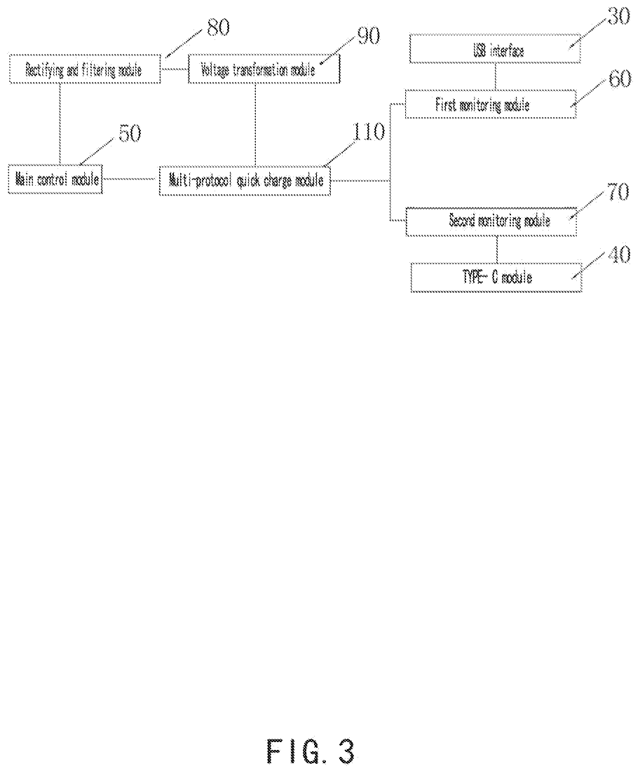

As shown in FIGS. 1-3, the present disclosure uses the following technical solution:

a multifunctional smart socket includes a housing 10, where a chip 20 is arranged in the housing 10, at least one universal serial bus (USB) interface 30 and at least one TYPE-C interface 40 are provided on a panel 100 of the housing 10, a multi-protocol quick charge module 110 is arranged on the chip 20, the USB interface 30 and the TYPE-C interface 40 are electrically connected to the multi-protocol quick charge module 110, a main control module 50 is further arranged on the chip 20, a first monitoring module 60 and a second monitoring module 70 are connected to the main control module 50, the first monitoring module 60 is electrically connected to the USB interface 30, the second monitoring module 70 is electrically connected to the TYPE-C interface 40, and the main control module 50 controls the multi-protocol quick charge module 110 to charge according to a signal of the first monitoring module 60 or the second monitoring module 70. The main control module 50 is further connected to a rectifying and filtering module 80 and a voltage transformation module 90, the rectifying and filtering module 80 is connected to the voltage transformation module 90, and the voltage transformation module 90 is connected to the multi-protocol quick charge module 110.

A voltage input end of the rectifying and filtering module 80 receives alternating current, rectifies and filters the alternating current into direct current and then outputs the direct current; and a voltage input end of the voltage transformation module 90 receives the direct current, and a voltage output end of the voltage transformation module is coupled to a power input port of the multi-protocol quick charge module 110, transforms input voltage of the voltage input end of the voltage transformation module into power supply voltage and then outputs the power supply voltage.

The multi-protocol quick charge module 110 supports a USB TypeC power delivery 2.0 (PD2.0)/power delivery 3.0 (PD3.0)/pulse per second dynamic feedback protocol (PPS DFP), quick charge 3.0 (QC3.0)/quick charge 2.0 (QC2.0), a fast charge protocol (FCP), a super charge protocol (SCP), adaptive fast charge (AFC), mediatek pump express plus 2.0/1.1 (MTK PE+2.0/1.1), Samsung 2.0A and a battery charging 1.2 (BC1.2) protocol.

The present disclosure detects an access device by means of the first monitoring module 60 and the second monitoring module 70, for example, when the first monitoring module 60 detects that a charge device exists in the USB interface 30 and the second monitoring module 70 detects that no charge device exists in the TYPE-C interface, the first monitoring module 60 sends the signal of the first monitoring module to the main control module 50, and the main control module 50 controls the multi-protocol quick charge module 110 to quickly charge the charge device in the USB interface 30; otherwise, if the second monitoring module 70 detects that the charge device exists in the TYPE-C interface and the first monitoring module 60 detects that no charge device exists in the USB interface 30, the second monitoring module 70 sends the signal to the main control module 50, and the main control module 50 controls the multi-protocol quick charge module 110 to quickly charge the charge device in the TYPE-C interface; and when the signals are detected in the first monitoring module 60 and the second monitoring module 70 at the same time, the main control module 50 controls the multi-protocol quick charge module 110 to carry out common charge, where output voltage of quick charge and common charge ranges from 3 V to 20 V, where the output voltage of quick charge is preferably 20 V, and the output voltage of common charge is preferably 5 V, and charge power of quick charge and common charge is 65 W.

Certain words may be used throughout the description and claims to refer to particular assemblies. It will be appreciated by those skilled in the art that hardware manufacturers may refer to the same assembly with different nouns. The description and claims do not take differences in names as a way to distinguish assemblies, but rather take differences in function of assemblies as a criterion for distinguishing. “Contain” as mentioned throughout the description and claims is an open-ended term and thus, should be interpreted to mean “contain, but not limited to”. “Approximately” means that within an acceptable error range, those skilled in the art are able to solve the technical problem within a certain error range to basically achieve the technical effect.

It should be noted that, terms “include”, “contain”, or any other variations thereof are intended to cover non-exclusive inclusions, such that commodities or systems including a series of elements not only include those elements, but also include other elements that are not explicitly listed, or further includes inherent elements of the commodities or the systems. Without more restrictions, the elements defined by the sentence “includes a . . . ” do not exclude the existence of other identical elements in the commodities or systems including the elements.

What is described above shows and describes several preferred embodiments of the present disclosure, but as previously described, it should be understood that the present disclosure is not limited to the form disclosed herein, is not to be considered exclusive of other embodiments, and may be used in various other combinations, modifications and environments, and is modified by means of the above teachings or skill or knowledge in the related field within the scope of the inventive creation described herein. Modifications and changes made by those skilled in the art without departing from the spirit and scope of the present disclosure should all fall within the scope of protection of the appended claims of the present disclosure.

What is claimed is:

1. A multifunctional smart socket, comprising a housing, wherein a chip is arranged in the housing, a universal serial bus (USB) interface and a TYPE-C interface are provided on a panel of the housing; a multi-protocol quick charge module is arranged on the chip, and the USB interface and the TYPE-C interface are electrically connected to the multi-protocol quick charge module; and a main control module is further arranged on the chip, a first monitoring module and a second monitoring module are connected to the main control module, the first monitoring module is electrically connected to the USB interface, the second monitoring module is electrically connected to the TYPE-C interface, and the main control module controls the multi-protocol quick charge module to charge according to a signal of the first monitoring module or the second monitoring module.

2. The multifunctional smart socket according to claim 1, wherein the main control module is further connected to a rectifying and filtering module and a voltage transformation module, the rectifying and filtering module is connected to the voltage transformation module, and the voltage transformation module is connected to the multi-protocol quick charge module.

3. The multifunctional smart socket according to claim 2, wherein the multi-protocol quick charge module supports a USB TypeC power delivery 2.0 (PD2.0)/power delivery 3.0 (PD3.0)/pulse per second dynamic feedback protocol (PPS DFP), quick charge 3.0 (QC3.0)/quick charge 2.0 (QC2.0), a fast charge protocol (FCP), a super charge protocol (SCP), adaptive fast charge (AFC), mediatek pump express plus 2.0/1.1 (MTK PE+2.0/1.1), Samsung 2.0A and a battery charging 1.2 (BC1.2) protocol.
